(19) United States
(12) Patent Application Publication
(10) Pub. No.: US 2025/0377239 A1
(43) Pub. Date: Dec. 11, 2025

(54) SUBSURFACE IMAGING USING LASER VIBROMETRY

(71) Applicant: X Development LLC, Mountain View, CA (US)

(72) Inventors: Alex S. Miller, Cambridge, MA (US); Artem Goncharuk, Mountain View, CA (US); Jaewoo Kim, Houston, TX (US)

(21) Appl. No.: 19/307,662

(22) Filed: Aug. 22, 2025

Related U.S. Application Data
(63) Continuation of application No. PCT/US2024/021288, filed on Mar. 25, 2024.
(60) Provisional application No. 63/491,837, filed on Mar. 23, 2023.

(51) Int. Cl. G01H 9/00; G01V 1/00; G01V 1/22; G01V 1/28

(52) U.S. Cl. CPC G01H 9/002; G01V 1/003; G01V 1/226; G01V 1/282

(57) ABSTRACT

Techniques for generating a subsurface image include analyzing a region to be sensed to determine a plurality of reflector locations; and performing a survey. Performing the survey includes irradiating a plurality of reflectors positioned in the plurality of determined reflector locations with coherent electromagnetic energy; identifying one or more vibrations of the plurality of reflectors based on reflected electromagnetic energy from the plurality of reflectors; and generating survey data associated with the identified vibrations for at least one reflector of the plurality of reflectors. The techniques include providing the survey data as input to a machine learning algorithm; and generating, using the machine learning algorithm, a subsurface image associated with the region to be sensed.

### CROSS-REFERENCE TO RELATED APPLICATIONS

This application is a continuation of, and claims priority under 35 U.S.C. § 120 to, International Application No. PCT/US2024/021288, filed Mar. 25, 2024, which in turn claims the benefit of U.S. Provisional Application No. 63/491,837, filed Mar. 23, 2023, the disclosures of which are expressly incorporated herein by reference in their entirety.

### TECHNICAL FIELD

This disclosure generally relates to generating subsurface images using laser vibrometry.

### BACKGROUND

Subsurface exploration can be performed using many techniques. Many applications involve directly recording seismic or acoustic energy in the subsurface. However, precision sensing in other fields has enabled other means of measuring subsurface energy and generating subsurface imaging.

### SUMMARY

In an example implementation, a method for generating a subsurface image includes analyzing a region to be sensed to determine a plurality of reflector locations; and performing a survey. Performing the survey includes irradiating a plurality of reflectors positioned in the plurality of determined reflector locations with coherent electromagnetic energy; identifying one or more vibrations of the plurality of reflectors based on reflected electromagnetic energy from the plurality of reflectors; and generating survey data associated with the identified vibrations for at least one reflector of the plurality of reflectors. The method includes providing the survey data as input to a machine learning algorithm; and generating, using the machine learning algorithm, a subsurface image associated with the region to be sensed.

In an aspect combinable with the example implementation, analyzing a region to be sensed includes performing an initial vibrometer survey to identify noise levels within the region.

In another aspect combinable with one, some, or all of the previous aspects, the coherent electromagnetic energy includes at least two coherent beams, with each beam of the at least two coherent beams at a different frequency.

Another aspect combinable with one, some, or all of the previous aspects further includes identifying the reflected electromagnetic energy at two or more locations, and wherein the survey data includes vibrations in two or more dimensions.

In another aspect combinable with one, some, or all of the previous aspects, each reflector of the plurality of reflectors is mounted to a device embedded in a surface, and each reflector is configured to receive seismic energy from a subsurface of the region to be sensed.

In another aspect combinable with one, some, or all of the previous aspects, the irradiating and the identifying is performed using a laser vibrometer.

Another aspect combinable with one, some, or all of the previous aspects further includes inducing seismic energy from a seismic source in the region while identifying the one or more vibrations of the plurality of reflectors.

In another example implementation, an apparatus that includes non-transitory, computer readable storage medium that stores instructions that, when executed by at least one processor, cause the at least one processor to perform operations including: identifying a plurality of reflector locations in a region to be sensed; identifying output data from a survey performed by irradiating a plurality of reflectors positioned in the plurality of determined reflector locations with coherent electromagnetic energy and identifying one or more vibrations of the plurality of reflectors based on reflected electromagnetic energy from the plurality of reflectors; generating, with the output data from the survey, survey data associated with the identified vibrations for at least one reflector of the plurality of reflectors; providing the survey data as input to a machine learning algorithm; and generating, using the machine learning algorithm, a subsurface image associated with the region to be sensed.

In an aspect combinable with the example implementation, the plurality of reflector locations are determined by performing an initial vibrometer survey to identify noise levels within the region.

In another aspect combinable with one, some, or all of the previous aspects, the coherent electromagnetic energy includes at least two coherent beams, with each beam of the at least two coherent beams at a different frequency.

In another aspect combinable with one, some, or all of the previous aspects, the reflected electromagnetic energy is identified at two or more locations, and the output data from the survey includes vibrations in two or more dimensions.

In another aspect combinable with one, some, or all of the previous aspects, each reflector of the plurality of reflectors is mounted to a device embedded in a surface, and each reflector is configured to receive seismic energy from a subsurface of the region to be sensed.

In another aspect combinable with one, some, or all of the previous aspects, the output data from the survey includes data from a laser vibrometer.

In another aspect combinable with one, some, or all of the previous aspects, the output data from the survey includes vibrations of the reflectors from inducing seismic energy from a seismic source in the region.

In another example implementation, a system for generating a subsurface image includes a source of coherent electromagnetic energy; a plurality of reflectors positioned in a plurality of reflector locations in a region, each of the plurality of reflectors positioned to be irradiated with the coherent electromagnetic energy from the source of coherent electromagnetic energy; and a control system. The control system includes one or more processors; and one or more tangible, non-transitory media operably connectable to the one or processors and storing a machine learning model that, when executed, cause the one or more processors to perform operations including identifying output data from a survey performed by irradiating the plurality of reflectors positioned in the plurality of determined reflector locations with the coherent electromagnetic energy and identifying one or more vibrations of the plurality of reflectors based on reflected electromagnetic energy from the plurality of reflectors; generating, with the output data from the survey, survey data associated with the identified vibrations for at least one reflector of the plurality of reflectors; providing the survey data as input to a machine learning algorithm; and generating, using the machine learning algorithm, a subsurface image associated with the region to be sensed.

In an aspect combinable with the example implementation, the plurality of reflector locations are determined by performing an initial vibrometer survey to identify noise levels within the region.

In another aspect combinable with one, some, or all of the previous aspects, the coherent electromagnetic energy includes at least two coherent beams, with each beam of the at least two coherent beams at a different frequency.

In another aspect combinable with one, some, or all of the previous aspects, the operations include identifying the reflected electromagnetic energy at two or more locations, and the survey data includes vibrations in two or more dimensions.

In another aspect combinable with one, some, or all of the previous aspects, each reflector of the plurality of reflectors is mounted to a device embedded in a surface, and each reflector is configured to receive seismic energy from a subsurface of the region to be sensed.

In another aspect combinable with one, some, or all of the previous aspects, the source of the coherent electromagnetic energy includes a laser vibrometer, and the output data from the survey includes data from the laser vibrometer.

In another aspect combinable with one, some, or all of the previous aspects, the output data from the survey includes vibrations of the reflectors from inducing seismic energy from a seismic source in the region.

In another example implementation, a computer-implemented method for generating a subsurface image includes identifying, with one or more hardware processors, a plurality of reflector locations in a region to be sensed; identifying, with the one or more hardware processors, output data from a survey performed by irradiating a plurality of reflectors positioned in the plurality of determined reflector locations with coherent electromagnetic energy and identifying one or more vibrations of the plurality of reflectors based on reflected electromagnetic energy from the plurality of reflectors; generating, with the one or more hardware processors and with the output data from the survey, survey data associated with the identified vibrations for at least one reflector of the plurality of reflectors; providing, with the one or more hardware processors, the survey data as input to a machine learning algorithm; and generating, with the one or more hardware processors and using the machine learning algorithm, a subsurface image associated with the region to be sensed.

In an aspect combinable with the example implementation, the plurality of reflector locations are determined by performing an initial vibrometer survey to identify noise levels within the region.

In another aspect combinable with one, some, or all of the previous aspects, the coherent electromagnetic energy includes at least two coherent beams, with each beam of the at least two coherent beams at a different frequency.

In another aspect combinable with one, some, or all of the previous aspects, the reflected electromagnetic energy is identified at two or more locations, and the output data from the survey includes vibrations in two or more dimensions.

In another aspect combinable with one, some, or all of the previous aspects, each reflector of the plurality of reflectors is mounted to a device embedded in a surface, and each reflector is configured to receive seismic energy from a subsurface of the region to be sensed.

In another aspect combinable with one, some, or all of the previous aspects, the output data from the survey includes data from a laser vibrometer.

In another aspect combinable with one, some, or all of the previous aspects, the output data from the survey includes vibrations of the reflectors from inducing seismic energy from a seismic source in the region.

The details of one or more implementations of the subject matter described in this disclosure are set forth in the accompanying drawings and the description below. Other features, aspects, and advantages of the subject matter will become apparent from the description, the drawings, and the claims.

### DESCRIPTION OF DRAWINGS

This disclosure relates to generating subsurface images using laser vibrometry.

FIG. 1 illustrates an example system for observing the subsurface using one or more laser vibrometers.

FIG. 2 illustrates an example reflector layout for a laser vibrometer sensing seismic energy in a region to be sensed.

FIG. 3 is a schematic diagram of a computing system with a machine learning algorithm for generating imaging data of the subsurface.

FIG. 4 is a flowchart depicting an example process for generating subsurface images using laser vibrometry.

FIG. 5 is a schematic diagram of a computer system for performing operations according to the present disclosure.

### DETAILED DESCRIPTION

This disclosure describes a system and method for generating subsurface images using laser vibrometry. Laser vibrometers can measure with high precision distance and vibrations for an irradiated object. Additionally, vibrometers can function over a relatively long range, and provide near continuous data for a long period of time. By establishing an array of reflectors in a region to be sensed, laser vibrometers observing vibrations of those reflectors can provide near continuous measurements of the region with a high spatial density. This enables long term observation of subsidence and detailed two dimensional vibration.

In contrast to conventional methods which would use an array of seismic receivers (e.g., geophones) that must be installed at high relative cost, a single laser vibrometer can observe a large number of relatively cheap reflectors. Additional reflectors do not add significant cost and can be relatively easily installed. For example, reflectors can be installed on stakes that are embedded into the ground and configured to transmit vibrations along their lengths and to the reflector.

The laser vibrometers can then periodically (e.g., every second, every tenth of a second, every minute, or other period) irradiate each reflector and observe vibrations in the reflector. This vibrational information can be processed (e.g., denoised) and provided to a machine learning model along with additional data in order to generate a subsurface model. This can be used in many applications where particularized information about a specific region is required. For example, a carbon capture utilization and storage (CCUS) site may have a particular interest in the general seismic stability of a region, as well as an awareness of long term subsidence that may occur.

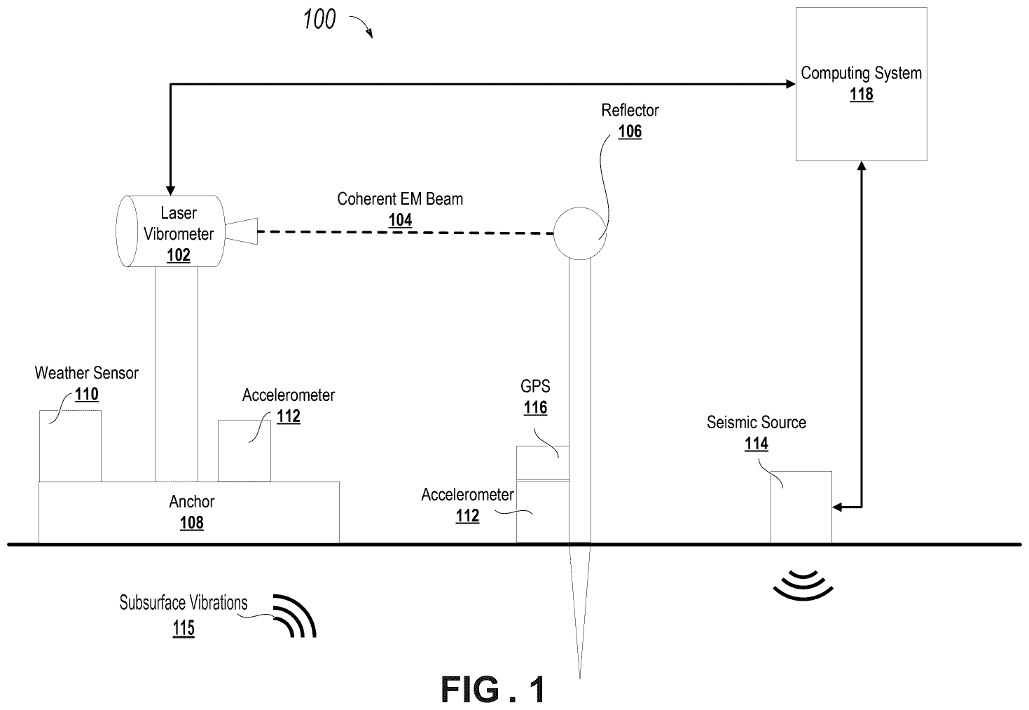

FIG. 1 illustrates an example system 100 for observing the subsurface using one or more laser vibrometers. A laser vibrometer 102 can be mounted to an anchor 108, and project a coherent electromagnetic beam 104 to a reflector 106. Reflector 106 can be embedded in the surface, as such subsurface vibrations 115 will propagate into the reflector 106. In some implementations, one or more accelerometers 112, weather sensor(s) 110, and seismic source(s) 114 can be included in system 100.

Laser vibrometer 102 is a remote vibration sensor. In general, the laser vibrometer generates two beams, one test beam and one target beam and performs interferometry between the beams in order to measure a Doppler shift in the target beam. This Doppler shift can be converted to a vibrational frequency and amplitude associated with the target. In implementations where the laser vibrometer 102 irradiates and measures vibrations across multiple reflectors 106, it can include a beam director, or a gimbal system, which directs or sweeps the beam across an area containing multiple reflectors 106. In some implementations, the laser vibrometer 102 is a scanning laser Doppler vibrometer (SLDV) that uses scanning mirrors to redirect the beam to sequentially measure vibrations of multiple targets. In some implementations, the laser vibrometer 102 is a continuous-scan laser Doppler vibrometer (CSLDV) which continuously sweeps its beam across the multiple targets, providing effectively simultaneous measurement of the multiple targets. In some implementations, the laser vibrometer 102 is a frequency modulated continuous wave (FMCW) lidar device.

The laser vibrometer 102 can emit a coherent electromagnetic beam 104, which can be a laser in the wavelength range of 200 nm to 2000 nm and can propagate to the reflector 106 and back to the vibrometer 102. In some implementations, multiple vibrometers are used with separately tuned coherent beams 104, each beam operating at a different frequency. In some implementations, a single laser vibrometer 102 emits multiple frequencies in a single (or multiple) beam. The multiple frequencies can be used to account for noise introduction based on propagation through the atmosphere. Since certain atmospheric disturbances, such as wind turbulence, temperature, and humidity can be highly dependent on wavelength, having multiple interrogating frequencies can allow for compensation from those disturbances.

The reflector 106 can be a simple reflective device. It can include a stake or other structure to allow it to be embedded into the ground. In some implementations the reflector 106 can be affixed to pre-existing infrastructure (e.g., a building, or radio antenna). In some implementations, the reflector is a retroreflector, and is configured to reflect incident radiation back toward the source while minimizing scattering. The reflector can be, for example, a corner retroreflector, or a cat's eye retroreflector. In some implementations, reflector 106 is tuned to reflect a specific wavelength of electromagnetic radiation (e.g., the optimal wavelength of the laser vibrometer 102) while absorbing or scattering other wavelengths. Reflector 106 can include additional components such as an accelerometer 112 which can be a MEMS accelerometer that is configured to measure vibrations at the surface.

Additionally, reflector 106 can include a GPS receiver 116 that can be used to determine precision location over time, and measure subsidence or receiver array geometry among other things. In some implementations, reflector 106 is a natural object (e.g., a rock or boulder) that is positioned at a known location within the region to be sensed. In some implementations there is a reflector array that includes a combination of manmade (e.g., retroreflectors) and naturally (e.g., boulder or tree) reflecting objects. In some implementations, the reflectors 106 are corner cubes integrated into 3D printed spikes, which can be inserted into the ground. In some implementations, the stakes are aluminum poles. In some implementations, the reflectors 106 include straps or bindings, or can otherwise be affixed to infrastructure that is already in place such as fence poles, buildings, signs, or other objects.

In some implementations, the laser vibrometer 102 is mounted to an anchor 108. Anchor 108 can be a platform or foundation that is configured to reduce or eliminate seismic vibrations that are transmitted to the laser vibrometer, reducing overall system noise. In some implementations, anchor 108 is an active platform, with suspension systems that actively damp vibrational energy and stabilizes the position of the laser vibrometer 102. In some implementations, the anchor 108 is a passive system such as a wood or steel platform that rests on top of the surface. Anchor 108 can include one or more accelerometers 112, which can be used similarly to the reflector 106 in order to compensate for, or anticipate, noise.

A weather sensor 110 can be provided to measure local temperature, humidity, illuminance, wind speed, precipitation, atmospheric transmissivity, or other environmental parameters. Data from weather sensor 110 can be used to adapt or optimize the coherent electromagnetic beam 104 or other operations of the laser vibrometer 102. For example, during reduced visibility (e.g., fog or rain) the laser vibrometer 102 could reduce its scan rate, irradiating each reflector 106 for longer in order to compensate for increased atmospheric distortion.

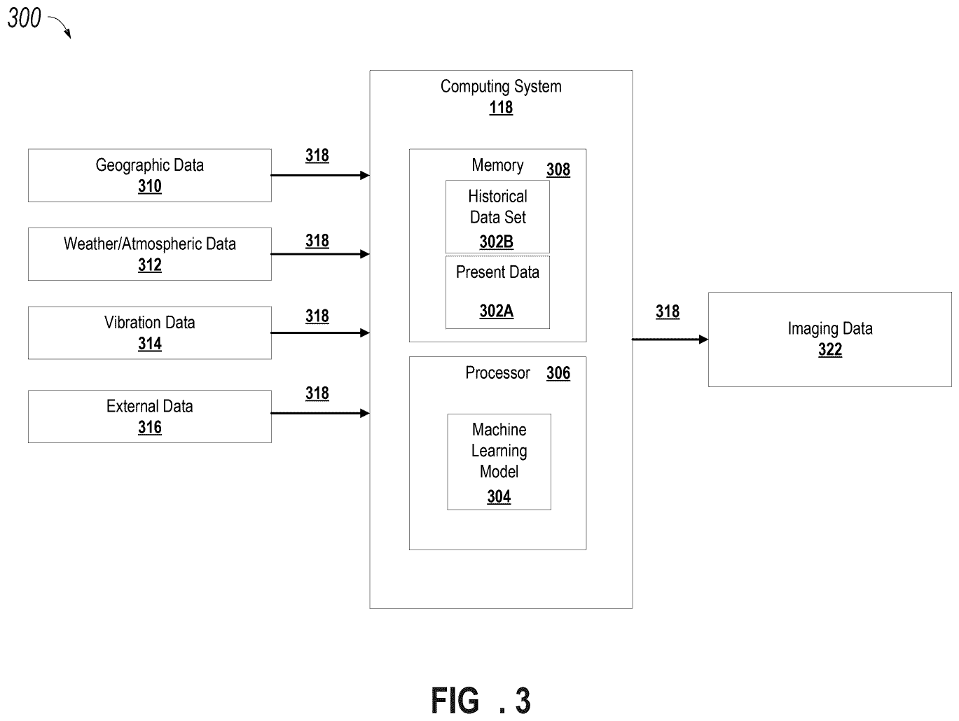

A computing system 118 can communicate with the laser vibrometer 102, and optionally, the seismic source 114 as well as other components of system 100 (e.g., accelerometer 112, weather sensor 110, or GPS 116) and external systems such as third party meteorological data repositories, or other external entities. In some implementations, the seismic source 114 is a repetitive source that is time-synced with the computing system 118 and the laser vibrometer 102. The computing system 118 generally can receive data from the laser vibrometer, and other sources, and generate insights related to the subsurface based on the received data. Computing system 118 is discussed in more detail below with respect to FIG. 3.

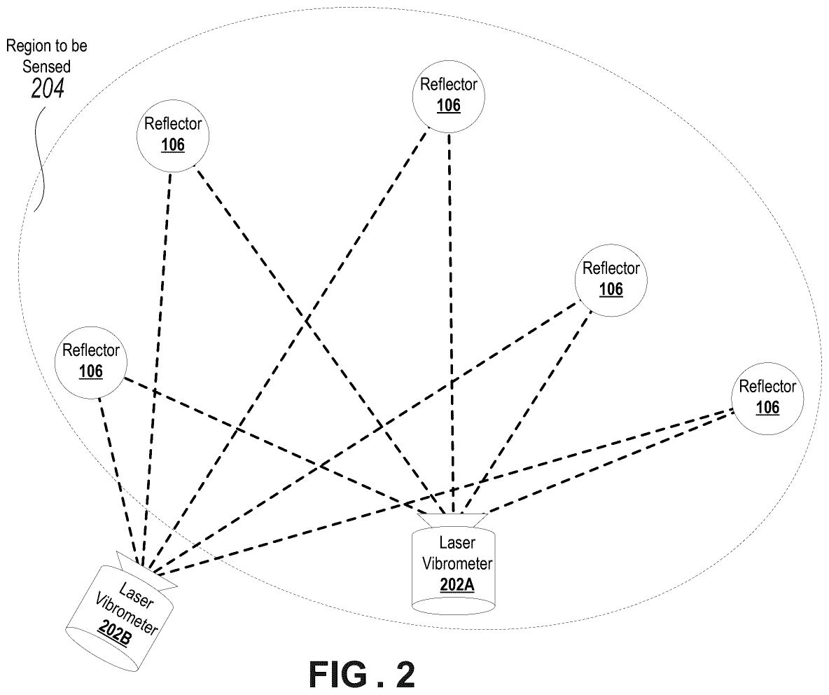

FIG. 2 illustrates an example reflector layout for a laser vibrometer sensing seismic energy in a region to be sensed 204. In the illustrated example, there are two laser vibrometers 202A and 202B, which can be the same, or different devices. In some implementations, each vibrometer emits a different frequency to reduce interference.

Laser vibrometers 202A and 202B can be configured to scan the array of reflectors 106A measuring vibrations at each reflector throughout the region to be sensed 204. By positioning the two laser vibrometers 202A and 202B in different locations, two dimensional vibration patterns can be determined for each reflector 106, which can then be used to build a two dimensional seismic energy profile at each point in the region to be sensed 204. It should be noted that FIG. 2 is not illustrated to scale, and the distance between each reflector 106 and laser vibrometer 202A and 202B can be hundreds or thousands of meters. For example, the laser vibrometers 202A and 202B can be configured to optimally work at a distance of 100 m to 2 km. In some implementations, the laser vibrometers 202A and 202B operate at a wavelength of 1550 nm and can scan points at greater than one scan per second.

FIG. 3 is a schematic diagram of a computing system 300 with a machine learning algorithm for generating imaging data of the subsurface. The computing system 118 can receive data from various systems (e.g., the laser vibrometer 102 of FIG. 1) via a communications link 318. The communication link 318 can be but is not limited to a wired communication interface (e.g., USB, Ethernet, fiber optic) or wireless communication interface (e.g., Bluetooth, ZigBee, WiFi, infrared (IR), CDMA2000, etc.). The communication link 318 can be used to communicate directly or indirectly, e.g., through a network, with the computing system 118.

The computing system 188 receives present data 302A from various sources via the communications link 318. Present data 302A can be data included in the most recent readings taken from a laser vibrometer and can be vibration data 314 or other information. Present data 302A can include, but is not limited to geographic data 310, vibration data 314 (which can include data from one or more laser vibrometers reading reflected energy from one or more reflectors), external data 316 which can be recorded by an additional source, including weather data (e.g., temperature, humidity, sunlight, etc.) from a weather sensor, and external data 316 which can include other imaging data sources such as a ground penetrating radar, or other subsurface imaging device being used in conjunction with the systems described herein. In some implementations, the present data 302A can be received in real-time or near real-time. Real-time can mean within seconds, or minutes, or with no intentional delay between collection of data and receipt of data. The present data 302A is then used by the machine learning model 304 operating with a processor 306 to generate a quantified output.

Geographic data 310 can include survey data and topography data associated with the region to be sensed. In some implementations, geographic data 310 includes an initial vibrometer survey that establishes a baseline noise level for laser vibrometer readings throughout the region to be sensed. In some implementations, geographic data 310 is used initially to establish a suggested, or recommended set of locations to place reflectors in order to maximize the useful signal generated by the laser vibrometer(s). In some implementations, geographic data 310 includes satellite imagery of the region to be sensed.

In some implementations, sensed geographic data 310 is enriched prior to being transmitted to the computing system 118. For example, the geographic data 310 can be tagged with location and timing information, as well as specific features of the data can be tagged (e.g., ridges, boulders, trees, elevation, subsurface composition, etc.).

Weather/Atmospheric data 312 can be collected real-time in one or more locations within the region to be sensed and can be used to denoise or correlate received vibration signals. For example, wind or turbulent air can affect the sensed vibrations from the laser vibrometer, and sensed wind data can be used to compensate. Additional parameters that are measured can include, but are not limited to humidity, solar irradiance, temperature, time, radon levels, season, and other environmental factors.

Vibration data 314 can represent data collected from the laser vibrometer and includes vibration measurements from an array of reflections within the region being sensed. In some implementations, where there are multiple laser vibrometers, the vibration data 314 represents a two dimensional map of the motion of each target or reflector in the sensed region. This data can have very high temporal resolution, very accurate spatial resolution, or both. In some implementations, the vibration data 314 can be automatically adjusted based on environmental conditions (e.g., in response to a request from computing system 118). The vibration data 314 can, for example, during periods of adverse environmental conditions (e.g., fog, rain, etc.) include a reduced number of targets that are scanned for longer periods. In this manner, the computing system 118 can trade spatial sampling rate for temporal sampling rate (or vice versa).

External data 316 includes data that is not directly related to the seismic activity. For example, external data 320 can include general weather data (e.g., forecasted temperature, humidity, precipitation, solar irradiance, etc.) as well as time, other data (e.g., local construction operations or recent earthquake events), or other data related to the subsurface in the region being sensed. In some implementations external data 320 includes subsurface images from additional sources (e.g., ground penetrating radar, or gravimetric sensors) which can be used by the machine learning model 304.

The computing system 118 can store a historical data set 302B in memory 308. The historical data set can include all data that has previously been used in a particular region, or a subset of the previous data. The historical data set 302B can also include data relating to common trends seen across multiple regions or locations, or trends seen among particular locations or regions or any suitable combination thereof.

The machine learning model 304 receives the present data 302A, and the historical data 302B and generates a quantified output. For example, the machine learning model 304 can compare the vibration data 314 with the weather/atmospheric data 312 and external data 316 to generate imaging data 322. Imaging data 322 can represent information regarding the subsurface such as long term subsidence, seismic stability, or general seismic activity. In some implementations, the imaging data 322 can include location, form, material, and contents of a target subsurface region.

In some implementations, the machine learning model 304 is a deep learning model that employs multiple layers of models to generate an output for a received input. A deep neural network is a deep machine learning model that includes an output layer and one or more hidden layers that each apply a non-linear transformation to a received input to generate an output. In some cases, the neural network may be a recurrent neural network. A recurrent neural network is a neural network that receives an input sequence and generates an output sequence from the input sequence.

In particular, a recurrent neural network uses some or all of the internal state of the network after processing a previous input in the input sequence to generate an output from the current input in the input sequence. In some other implementations, the machine learning model 304 is a convolutional neural network. In some implementations, the machine learning model 304 is an ensemble of models that may include all or a subset of the architectures described above.

In some implementations, the machine learning model 304 can be a feedforward auto-encoder neural network. For example, the machine learning model 304 can be a multilayer auto-encoder neural network. The machine learning model 304 may include an input layer, one or more hidden layers, and an output layer. In some implementations, the neural network has no recurrent connections between layers. Each layer of the neural network may be fully connected to the next, e.g., there may be no pruning between the layers. The neural network may include an optimizer for training the network and computing updated layer weights, such as, but not limited to, ADAM, Adagrad, Adadelta, RMSprop, Stochastic Gradient Descent (SGD), or SGD with momentum. In some implementations, the neural network may apply a mathematical transformation, e.g., a convolutional transformation or factor analysis to input data prior to feeding the input data to the network.

In some implementations, the machine learning model 304 can be a supervised model. For example, for each input provided to the model during training, the machine learning model 304 can be instructed as to what the correct output should be. The machine learning model 304 can use batch training, e.g., training on a subset of examples before each adjustment, instead of the entire available set of examples. This may improve the efficiency of training the model and may improve the generalizability of the model. The machine learning model 304 may use folded cross-validation. For example, some fraction (e.g., the “fold”) of the data available for training can be left out of training and used in a later testing phase to confirm how well the model generalizes. In some implementations, the machine learning model 304 may be an unsupervised model. For example, the model may adjust itself based on mathematical distances between examples rather than based on feedback on its performance.

The machine learning model 304 can be, for example, a deep-learning neural network or a “very” deep learning neural network. For example, the machine learning model 304 can be a convolutional neural network. The machine learning model 304 can be a recurrent network. The machine learning model 304 can have residual connections or dense connections. The machine learning model 304 can be an ensemble of all or a subset of these architectures. The model may be trained in a supervised or unsupervised manner. In some examples, the model may be trained in an adversarial manner. In some examples, the model may be trained using multiple objectives, loss functions or tasks.

In some implementations, the machine learning model 304 can generate imaging data 322 based on recorded data only. In other words, the imaging data 322 can be a new image, based on no prior collections. In some implementations, the machine learning model 304 can use vibration data 314 to improve a previously existing subsurface image or survey that was acquired by other means (e.g., ground penetrating radar). For example, a gravimetric survey can be enriched to include increased information such as more temporal resolution, or more spatial resolution, based on vibration data 314, weather/atmospheric data 312, and geographic data 310 received at the machine learning model 304 in order to create imaging data 322.

In some implementations, the machine learning model 304 can provide suggested additional data that could further improve the output of the machine learning model 304. For example, the machine learning model 304 could provide analysis of the vibration data 314 and suggested reflector array arrangements to enhance future imaging data 322. In another example, the machine learning model 304 could provide recommended locations for additional sensors or sources (e.g., seismic source 114 of FIG. 1) to record future transients and secondary transients.

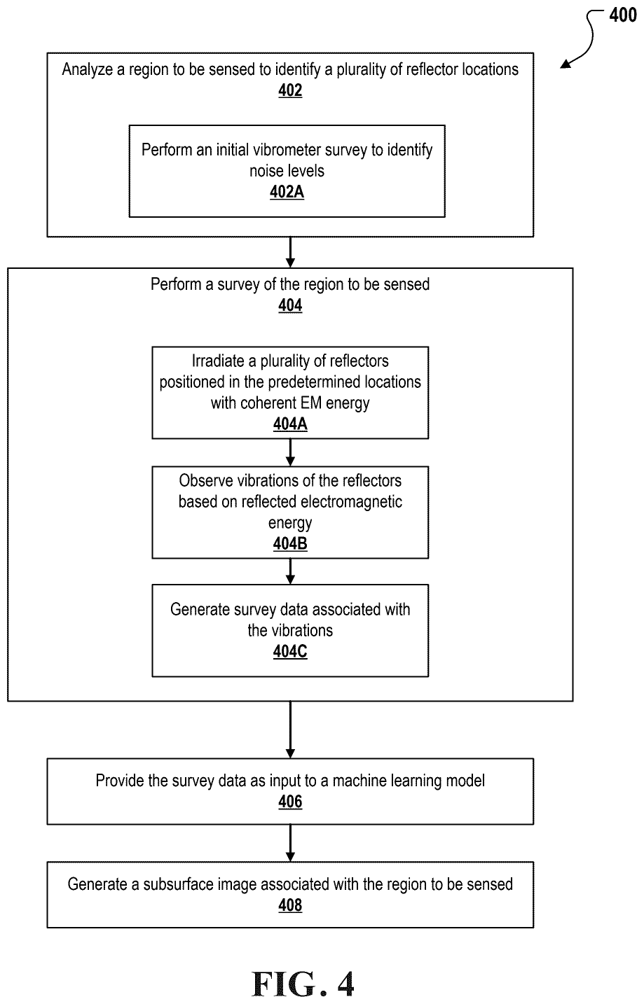

FIG. 4 is a flowchart depicting an example process 400 for generating subsurface images using laser vibrometry. It will be understood that one or more steps of the process 400 may be performed, for example, by any suitable system, environment, software, and hardware, or a combination of systems, environments, software, and hardware as appropriate. In some instances, one or more steps of the process 400 can be performed by the system 100, or portions thereof, described in FIG. 1, as well as other components or functionality described in other portions of this description. In other instances, one or more steps of the process 400 may be performed by a plurality of connected components or systems. Any suitable system(s), architecture(s), or application(s) can be used to perform the illustrated operations.

At 402, a region to be sensed is analyzed to determine a plurality of locations in which to place reflectors. In some implementations the region is sensed using a combination of local and remote sensing techniques. For example, satellite imagery, topology data, and previous survey data can be used to generate an initial map of locations to place reflectors. And local sensing, such as a local vibrometer survey can be performed (402A). For example, reflectors, or test reflectors can be placed in a grid throughout the region to be sensed. An initial vibrometer measurement of each test reflector, along with additional data such as direct geophone readings, can be conducted in order to assess a relative signal to noise produced by each test reflector. In some implementations, this initial survey is done in the presence of an acoustic source or known seismic activity, to further calibrate the vibrometer readings. Upon completion of the initial survey, candidate reflector locations for long-term or continued sensing can be selected. In some implementations, the initial survey includes a full area 2D scan, which can identify reflections or reflective objects to use as supplemental sensing reflectors. These reflective objects can be, for example, boulders, street signs, windows, buildings, or other objects that are already present in the region to be sensed. Additionally, the initial survey can be used to identify regions or objects with a high signal to noise ratio. For example, a particular building may not have a particularly high reflectivity but may be located such that the path between it and the vibrometer is low noise, and as such, the building may be a good candidate object for future sensing.

At 404, a survey of the region to be sensed is performed. The survey can be conducted by a laser vibrometer or similar sensor and can include irradiating a plurality of reflectors that are positioned at the predetermined locations with coherent electromagnetic energy (404A). The laser vibrometer or similar sensor can observe vibrations in the reflectors (e.g., installed retroreflectors, or preexisting objects such as boulders) based on the reflected electromagnetic energy (404B). The vibrations can be used to generate survey data representing seismic energy based on the vibrations for each predetermined location (404C). In some implementations, multiple sensors or vibrometers are used, and are positioned at physically different locations. In these implementations, vibrations in two dimensions can be measured for each reflector, and the generated survey data can represent a two dimensional mapping of acoustic (e.g., seismic) energy in the region to be sensed. In some implementations, three dimensional measurements are possible, with three vibrometers operating on three different axis.

At 406, the generated survey data is provided as input to a machine learning model. Additional inputs to the machine learning model can include, but are not limited to local weather and atmospheric measurements, regional weather data, geographic data (e.g., altitude, slope, subsurface type, etc.) and other external data such as satellite imagery, geophone sensing, subsurface physics models, etc.

At 408, using the machine learning model, subsurface image data is generated. The subsurface image data can represent general geologic stability of the region, the location of one or more subsurface features, or be a representation of long-term subsidence and associated directions of motion. In some implementations, a seismic velocity model for the region can be generated by the machine learning model.

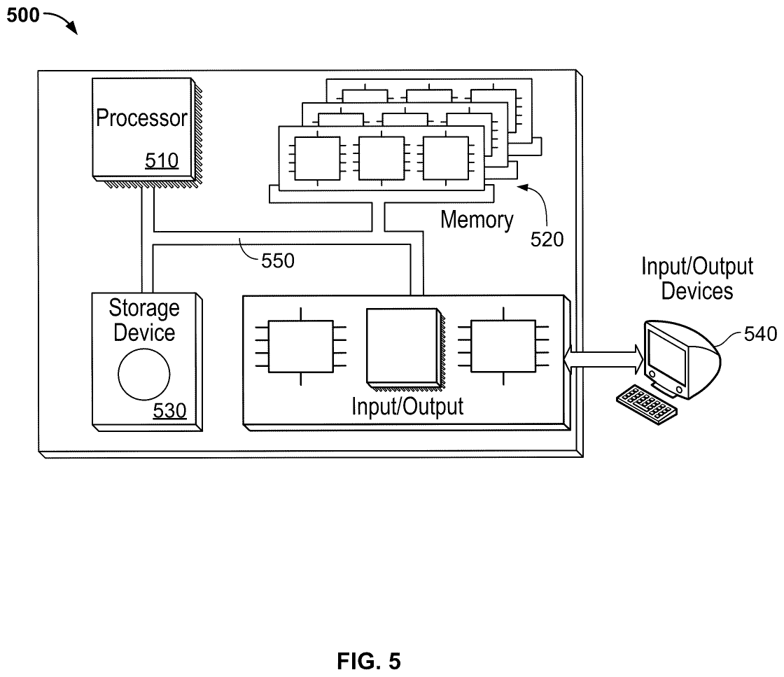

FIG. 5 is a schematic diagram of a computer system 500. The system 500 can be used to carry out the operations described in association with any of the computer-implemented methods described previously, according to some implementations. In some implementations, computing systems and devices and the functional operations described in this specification can be implemented in digital electronic circuitry, in tangibly-embodied computer software or firmware, in computer hardware, including the structures disclosed in this specification and their structural equivalents, or in combinations of one or more of them. The system 500 is intended to include various forms of digital computers, such as laptops, desktops, workstations, servers, blade servers, mainframes, and other appropriate computers. The system 500 can also include mobile devices, such as personal digital assistants, cellular telephones, smartphones, and other similar computing devices. Additionally, the system can include portable storage media, such as Universal Serial Bus (USB) flash drives. For example, the USB flash drives may store operating systems and other applications. The USB flash drives can include input/output components, such as a wireless transducer or USB connector that may be inserted into a USB port of another computing device.

The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. The processor may be designed using any of a number of architectures. For example, the processor 510 may be a CISC (Complex Instruction Set Computers) processor, a RISC (Reduced Instruction Set Computer) processor, or a MISC (Minimal Instruction Set Computer) processor.

In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 may be a floppy disk device, a hard disk device, an optical disk device, or a tape device.

The input/output device 540 provides input/output operations for the system 500. In one implementation, the input/output device 540 includes a keyboard and/or pointing device. In another implementation, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system, including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits). The machine learning model can run on Graphic Processing Units (GPUs) or custom machine learning inference accelerator hardware.

To provide for interaction with a user, the features can be implemented on a computer having a display device such as a CRT (cathode ray tube) or LCD (liquid crystal display) monitor for displaying information to the user and a keyboard and a pointing device, such as a mouse or a trackball by which the user can provide input to the computer. Additionally, such activities can be implemented via touchscreen flat-panel displays and other appropriate mechanisms.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The computer system can include clients and servers. A client and server are generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can, in some cases, be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The foregoing description is provided in the context of one or more particular implementations. Various modifications, alterations, and permutations of the disclosed implementations can be made without departing from scope of the disclosure. Thus, the present disclosure is not intended to be limited only to the described or illustrated implementations but is to be accorded the widest scope consistent with the principles and features disclosed herein.

What is claimed is:

1. A method for generating a subsurface image, comprising:
analyzing a region to be sensed to determine a plurality of reflector locations;
performing a survey, comprising:
irradiating a plurality of reflectors positioned in the plurality of determined reflector locations with coherent electromagnetic energy;
identifying one or more vibrations of the plurality of reflectors based on reflected electromagnetic energy from the plurality of reflectors; and
generating survey data associated with the identified vibrations for at least one reflector of the plurality of reflectors;
providing the survey data as input to a machine learning algorithm; and
generating, using the machine learning algorithm, a subsurface image associated with the region to be sensed.

2. The method of claim 1, wherein analyzing a region to be sensed comprises performing an initial vibrometer survey to identify noise levels within the region.

3. The method of claim 1, wherein the coherent electromagnetic energy comprises at least two coherent beams, with each beam of the at least two coherent beams at a different frequency.

4. The method of claim 1, comprising identifying the reflected electromagnetic energy at two or more locations, and wherein the survey data comprises vibrations in two or more dimensions.

5. The method of claim 1, wherein each reflector of the plurality of reflectors is mounted to a device embedded in a surface, and each reflector is configured to receive seismic energy from a subsurface of the region to be sensed.

6. The method of claim 1, wherein the irradiating and the identifying is performed using a laser vibrometer.

7. The method of claim 1, comprising inducing seismic energy from a seismic source in the region while identifying the one or more vibrations of the plurality of reflectors.

8. An apparatus that comprises non-transitory, computer readable storage medium that stores instructions that, when executed by at least one processor, cause the at least one processor to perform operations comprising:
identifying a plurality of reflector locations in a region to be sensed;
identifying output data from a survey performed by irradiating a plurality of reflectors positioned in the plurality of determined reflector locations with coherent electromagnetic energy and identifying one or more vibrations of the plurality of reflectors based on reflected electromagnetic energy from the plurality of reflectors;
generating, with the output data from the survey, survey data associated with the identified vibrations for at least one reflector of the plurality of reflectors;
providing the survey data as input to a machine learning algorithm; and
generating, using the machine learning algorithm, a subsurface image associated with the region to be sensed.

9. The apparatus of claim 8, wherein the plurality of reflector locations are determined by performing an initial vibrometer survey to identify noise levels within the region.

10. The apparatus of claim 8, wherein the coherent electromagnetic energy comprises at least two coherent beams, with each beam of the at least two coherent beams at a different frequency.

11. The apparatus of claim 8, wherein the reflected electromagnetic energy is identified at two or more locations, and the output data from the survey comprises vibrations in two or more dimensions.

12. The apparatus of claim 8, wherein each reflector of the plurality of reflectors is mounted to a device embedded in a surface, and each reflector is configured to receive seismic energy from a subsurface of the region to be sensed.

13. The apparatus of claim 8, wherein the output data from the survey comprises data from a laser vibrometer.

14. The apparatus of claim 8, wherein the output data from the survey comprises vibrations of the reflectors from inducing seismic energy from a seismic source in the region.

15. A system for generating a subsurface image, comprising:
a source of coherent electromagnetic energy;
a plurality of reflectors positioned in a plurality of reflector locations in a region, each of the plurality of reflectors positioned to be irradiated with the coherent electromagnetic energy from the source of coherent electromagnetic energy; and
a control system comprising:
one or more processors; and
one or more tangible, non-transitory media operably connectable to the one or processors and storing a machine learning model that, when executed, cause the one or more processors to perform operations comprising:
identifying output data from a survey performed by irradiating the plurality of reflectors positioned in the plurality of determined reflector locations with the coherent electromagnetic energy and identifying one or more vibrations of the plurality of reflectors based on reflected electromagnetic energy from the plurality of reflectors;
generating, with the output data from the survey, survey data associated with the identified vibrations for at least one reflector of the plurality of reflectors;
providing the survey data as input to a machine learning algorithm; and generating, using the machine learning algorithm, a subsurface image associated with the region to be sensed.

16. The system of claim 15, wherein the plurality of reflector locations are determined by performing an initial vibrometer survey to identify noise levels within the region.

17. The system of claim 15, wherein the coherent electromagnetic energy comprises at least two coherent beams, with each beam of the at least two coherent beams at a different frequency.

18. The system of claim 15, wherein the operations comprise identifying the reflected electromagnetic energy at two or more locations, and the survey data comprises vibrations in two or more dimensions.

19. The system of claim 15, wherein each reflector of the plurality of reflectors is mounted to a device embedded in a surface, and each reflector is configured to receive seismic energy from a subsurface of the region to be sensed.

20. The system of claim 15, wherein the source of the coherent electromagnetic energy comprises a laser vibrometer, and the output data from the survey comprises data from the laser vibrometer.

21. The system of claim 15, wherein the output data from the survey comprises vibrations of the reflectors from inducing seismic energy from a seismic source in the region.

22. A computer-implemented method for generating a subsurface image, comprising:
identifying, with one or more hardware processors, a plurality of reflector locations in a region to be sensed;
identifying, with the one or more hardware processors, output data from a survey performed by irradiating a plurality of reflectors positioned in the plurality of determined reflector locations with coherent electromagnetic energy and identifying one or more vibrations of the plurality of reflectors based on reflected electromagnetic energy from the plurality of reflectors;
generating, with the one or more hardware processors and with the output data from the survey, survey data associated with the identified vibrations for at least one reflector of the plurality of reflectors;
providing, with the one or more hardware processors, the survey data as input to a machine learning algorithm; and
generating, with the one or more hardware processors and using the machine learning algorithm, a subsurface image associated with the region to be sensed.

23. The computer-implemented method of claim 22, wherein the plurality of reflector locations are determined by performing an initial vibrometer survey to identify noise levels within the region.

24. The computer-implemented method of claim 22, wherein the coherent electromagnetic energy comprises at least two coherent beams, with each beam of the at least two coherent beams at a different frequency.

25. The computer-implemented method of claim 22, wherein the reflected electromagnetic energy is identified at two or more locations, and the output data from the survey comprises vibrations in two or more dimensions.

26. The computer-implemented method of claim 22, wherein each reflector of the plurality of reflectors is mounted to a device embedded in a surface, and each reflector is configured to receive seismic energy from a subsurface of the region to be sensed.

27. The computer-implemented method of claim 22, wherein the output data from the survey comprises data from a laser vibrometer.

28. The computer-implemented method of claim 22, wherein the output data from the survey comprises vibrations of the reflectors from inducing seismic energy from a seismic source in the region.
